(19) United States
(12) Patent Application Publication
(10) Pub. No.: US 2026/0142054 A1
(43) Pub. Date: May 21, 2026

(54) FLEXIBLE CHAIN LINK INTERCONNECT FOR HIGH FREQUENCY CIRCUITS

(71) Applicant: BAE Systems Information and Electronic Systems Integration Inc., Nashua, NH (US)

(72) Inventors: Kimberly Eilert, Mesa, AZ (US); Amrita V. Masurkar, Burlington, MA (US)

(73) Assignee: BAE Systems Information and Electronic Systems Integration Inc., Nashua, NH (US)

(21) Appl. No.: 18/949,097

(22) Filed: Nov. 15, 2024

(51) Int. Cl. H01B 5/00; B33Y 10/00; B33Y 80/00; H01B 13/008

(52) U.S. Cl. CPC H01B 5/002; B33Y 80/00; H01B 13/008; B33Y 10/00

(57) ABSTRACT

Techniques are provided for fabricating a flexible electrical interconnect. A methodology implementing the techniques according to an embodiment includes performing additive manufacturing to fabricate a chain comprising a plurality of link structures. Each link structure is shaped in a continuous and seamless loop and is coupled to at least one adjacent link structure such that a portion of each link structure traverses through an interior of the loop of the adjacent link structure. The method also includes coupling a first tensioner to a first of the link structures at a first end of the chain. The first tensioner is configured to electrically connect the first link structure to a circuit element. The method further includes coupling a second tensioner to a second of the link structures at a second end of the chain. The second tensioner is configured to electrically connect the second link structure to another circuit element.

### FIELD OF DISCLOSURE

The present disclosure relates to electrical connections, and more particularly to a flexible chain link interconnection for high frequency circuits.

### BACKGROUND

In many applications, electronic systems are required to fit into increasingly smaller form factors. Additionally, and particularly in military and aeronautic/avionic applications, these electronic systems must be able to tolerate large stresses, in the form of mechanical and thermal shocks, both during fabrication and operation, while maintaining high electrical conductivity between system components.

### BRIEF DESCRIPTION OF THE DRAWINGS

FIG. 1 illustrates a system employing flexible chain link interconnects, configured in accordance with certain embodiments of the present disclosure.

FIG. 2 illustrates flexible chain link interconnects under taut and slack conditions, in accordance with certain embodiments of the present disclosure.

FIG. 3 illustrates attenuation of flexible chain link interconnects under taut and slack conditions, in accordance with certain embodiments of the present disclosure.

FIG. 4 illustrates a multi-branch flexible chain link interconnect, configured in accordance with certain embodiments of the present disclosure.

FIG. 5 illustrates a flexible chain link interconnect with shielding, configured in accordance with certain embodiments of the present disclosure.

FIG. 6 illustrates a capacitive flexible chain link interconnect, configured in accordance with certain embodiments of the present disclosure.

FIG. 7 is a flowchart illustrating a methodology for fabrication of a flexible chain link interconnect, in accordance with an embodiment of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided herein for fabricating a flexible chain link electrical interconnect using additive manufacturing techniques. As noted above, electronic systems are often required to fit into increasingly smaller form factors and, particularly in military and aeronautic/avionic applications, these electronic systems must be able to tolerate large stresses, in the form of mechanical and thermal shocks, both during fabrication and operation, while maintaining high electrical conductivity between system components.

To this end, and in accordance with an embodiment of the present disclosure, a flexible chain link interconnect is disclosed which may be fabricated using additive manufacturing techniques. These flexible and conductive interconnects can be bent into 3-dimensional (3D) shapes during assembly, to fit into any required form factor, and still withstand large mechanical and thermal shocks, including vibrations, while providing high electrical conductivity. Chain link interconnects also eliminate the need for solder joints since the additive manufacturing process allows for the chain to be fabricated as a continuous single piece.

In accordance with an embodiment, a methodology implementing the techniques for fabrication of a flexible chain link interconnect includes using additive manufacturing techniques to fabricate a chain comprising a plurality of link structures. Each of the link structures is shaped in a continuous and seamless loop and is coupled to at least one adjacent link structure such that a portion of each of the link structure traverses through an interior of the loop of the adjacent link structure. The method also includes coupling a first tensioner to a first one of the link structures at a first end of the chain. The first tensioner is configured to electrically connect the first link structure to a first circuit element. The method further includes coupling a second tensioner to a second one of the link structures at a second end of the chain. The second tensioner is configured to electrically connect the second link structure to a second circuit element.

It will be appreciated that the techniques described herein may provide flexible and stress tolerant electrical connections between circuit components, compared to the rigid interconnections employed in circuit cards. The disclosed connection techniques also provide higher conductivity compared to systems that employ thinner metal structures in an attempt to achieve flexibility. Numerous embodiments and applications will be apparent in light of this disclosure.

### System Architecture

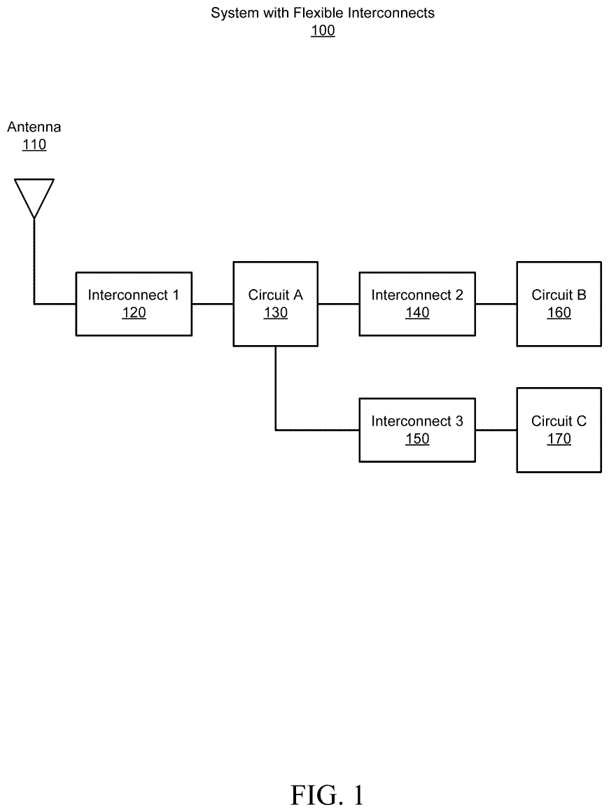

FIG. 1 illustrates a system 100 employing flexible chain link interconnects, configured in accordance with certain embodiments of the present disclosure. The system is shown to include an antenna 110 and three circuits: circuit A 130, circuit B 160, and circuit C 170. The antenna and circuits are electrically coupled by flexible chain link interconnects 120, 140, and 150, which will be described in greater detail below. It will be appreciated that the system shown in FIG. 1 is one example of the use of flexible interconnects. A more complex system comprising any number of circuits, antennas, connectors, and/or other electrical components may be configured to use the flexible chain link interconnects described herein.

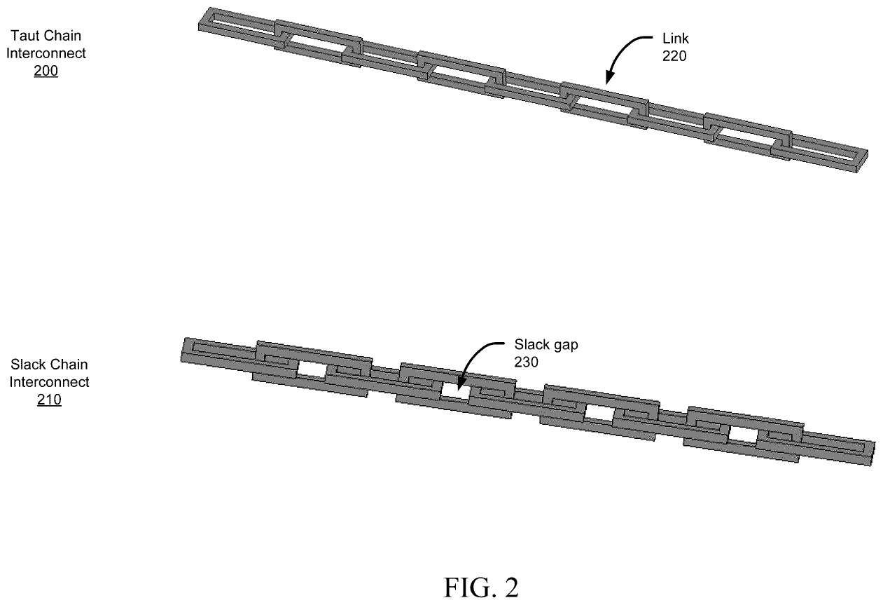

FIG. 2 illustrates flexible chain link interconnects under taut conditions 200 and slack conditions 210, in accordance with certain embodiments of the present disclosure. The interconnects are shown to comprise a number of link structures 220 arranged in a chain configuration. In some embodiments, the link structures 220 are shaped in a continuous and seamless loop and each link structure is coupled to at least one adjacent link structure such that a portion of each of the link structure traverses through an interior of the loop of the adjacent link structure. The link structures may be fabricated into the chain configuration using additive manufacturing techniques (e.g., 3D printing). Additive manufacturing allows the link structures to be shaped in a continuous and seamless loop while being coupled to adjacent link structures. In some embodiments, the link structures may be shaped as oval loops, rectangular loops (as shown in FIG. 2), or any other desired closed shape. The link structures may be fabricated from a conductive material, such as gold, copper, silver, or other metal, for example, so that the chains can transmit electrical signals with minimal resistance. In some embodiments, the link structures may be on the order of one millimeter in length.

Under taut conditions 200, a segment of each link structure is in contact with a segment of an adjacent link structure, as shown. Under slack conditions 210, there is a gap 230 between the segment of each link structure and the segment of the adjacent link structure, as shown. During normal operation of the system 100, the chain will typically be in a taut condition 200 to provide a low resistance electrical connection between the system circuits or components. When not tensioned, however, such as during initial assembly, the chain can be manipulated in 3D space and can be more easily positioned into a desired place on the circuits. Additionally, the ability of the chain to compress without breaking provides an advantage for surviving some types of mechanical or thermal shock.

In some embodiments, the flexible chain link interconnects can be fabricated separately from the circuitry and stored until needed. When a system is ready to be built, the stored chains can be cut to length and attached to the circuitry and other components as needed.

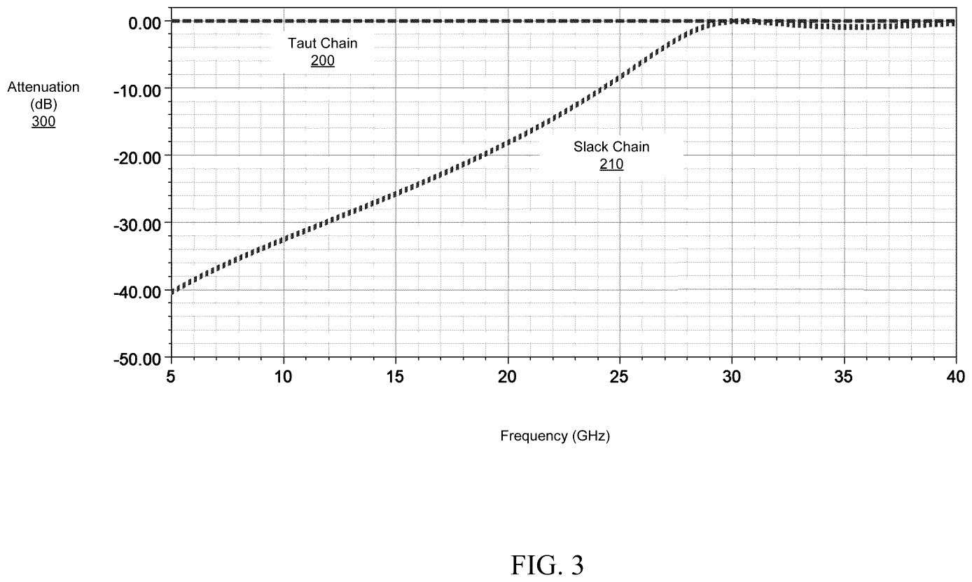

FIG. 3 illustrates attenuation 300 of flexible chain link interconnects under taut and slack conditions, in accordance with certain embodiments of the present disclosure. This plot shows the attenuation in dB, as a function of frequency, of a signal being conducted through a taut chain 200 and a slack chain 210. In this example, the slack chain has a 1 micrometer gap between links. As can be seen, the taut chain 200 acts as a relatively good conductor at all frequencies of interest. The slack chain 210, however, exhibits a high-pass behavior where frequencies below 30 GHz are attenuated, down to as much as 40 dB at 5 GHz. In some embodiments, this behavior could be used to create isolation during a stress event, in which one circuit could be isolated from other circuits by the slack that is introduced into the chain.

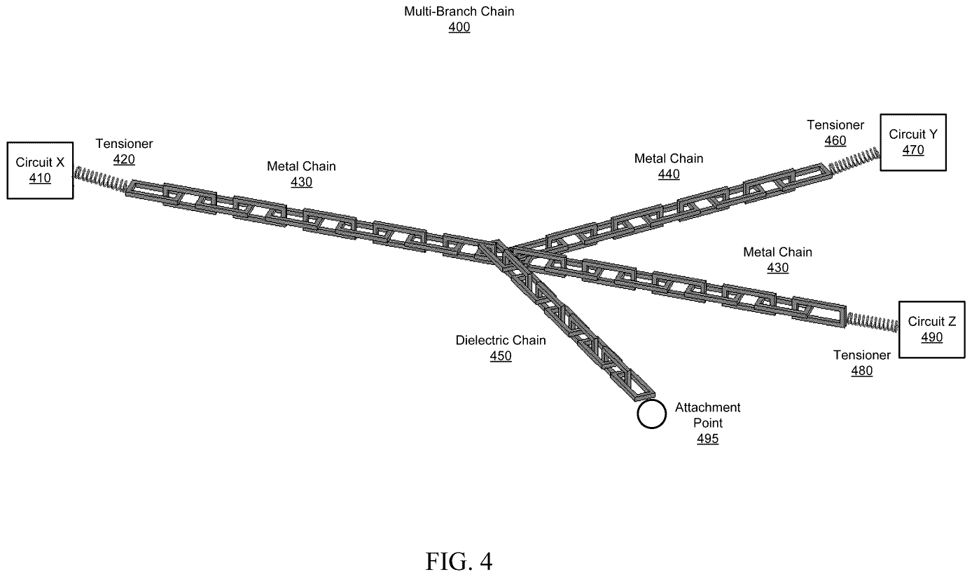

FIG. 4 illustrates a multi-branch flexible chain link interconnect 400, configured in accordance with certain embodiments of the present disclosure. The multi-branch flexible chain link interconnect 400 is shown to include a first metal chain 430, connecting circuit X 410 to circuit Z 490, along with a second metal chain 440 branching off of the first metal chain, to connect to circuit Y 470. This arrangement acts as an electrical splitter. A third chain 450 is also shown which connects to a mechanical attachment point or anchor and serves to provide tensioning to increase the mechanical stability of the multi-branch interconnect 400. The third chain may be fabricated from a dielectric material since it is not meant to conduct a signal. In some embodiments, the dielectric material may be a polymer (e.g., polymethyl Methacrylate), silicon dioxide, or a ceramic. In other embodiments the chain link interconnect 400 can be a sectional piece or segment of the overall electrical connection between the circuits and there may be one or more traditional electrical conductors coupling to the chain link interconnect 400.

The multi-branch flexible chain link interconnect 400 in this example is also shown to include tensioners 420, 460, and 480, configured to provide electrical coupling and mechanical tension between the final link of each chain and the associated circuit 410, 470, and 490. For example, the springs may be attached to a pin of an integrated circuit or a lead of an electrical component. In some embodiments, the tensioners may be conductive springs such as, for example, microelectromechanical system (MEMS) springs.

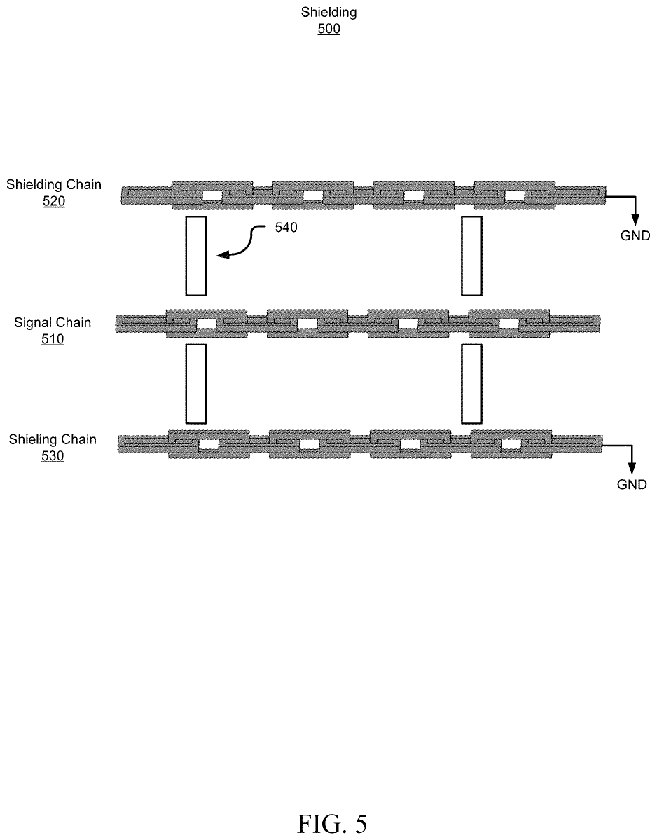

FIG. 5 illustrates a flexible chain link interconnect with shielding 500, configured in accordance with certain embodiments of the present disclosure. Conductors that propagate high frequency signals, for example signals in the GHz range, typically require shielding to reduce electromagnetic interference. Flexible chain link interconnects can be used to provide such shielding. As shown in FIG. 5, one or more chains 520, 530 may be grounded and positioned adjacent to a signal carrying chain 510, to provide electromagnetic shielding. In some embodiments, particularly for applications at the highest frequency ranges, numerous shielding chains may be employed to more fully encircle the signal chain 510. In some embodiments dielectric spacers 540 may be employed to separate the shielding chains 520, 530 from the signal chain 510. In a further example, a braid, flexible sleeve, or shield can cover individual chain links or the entire chain link interconnect. Conductive sleeving can also be grounded, tensioned, and spaced apart from the signal chain by dielectric spacers.

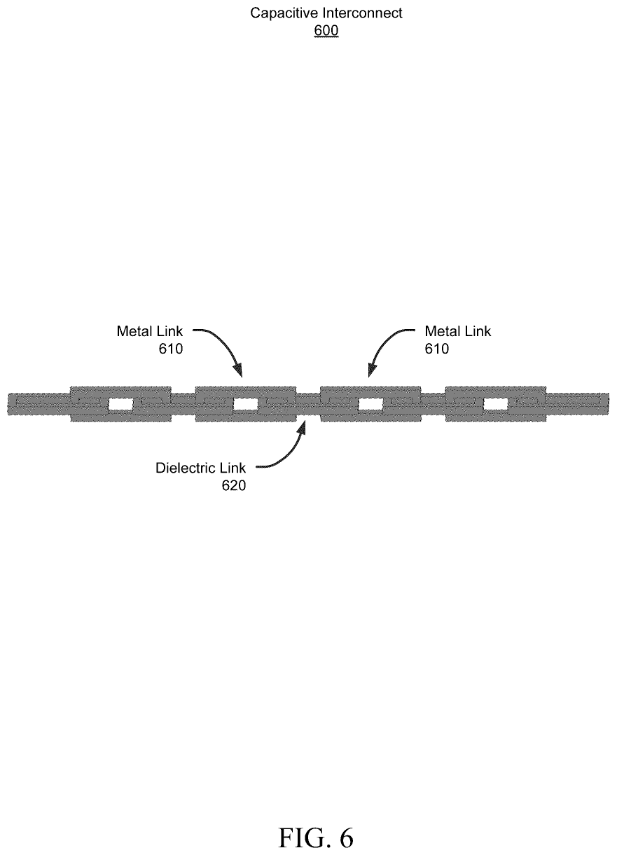

FIG. 6 illustrates a capacitive flexible chain link interconnect 600, configured in accordance with certain embodiments of the present disclosure. A capacitive chain is shown to include one or more dielectric links 620 located within the chain of metal links 610. The dielectric link, located between conductive metallic portions of the chain causes the chain to function as a capacitor which may be useful in some applications where two circuits need to be capacitively coupled using a flexible interconnect.

### Methodology

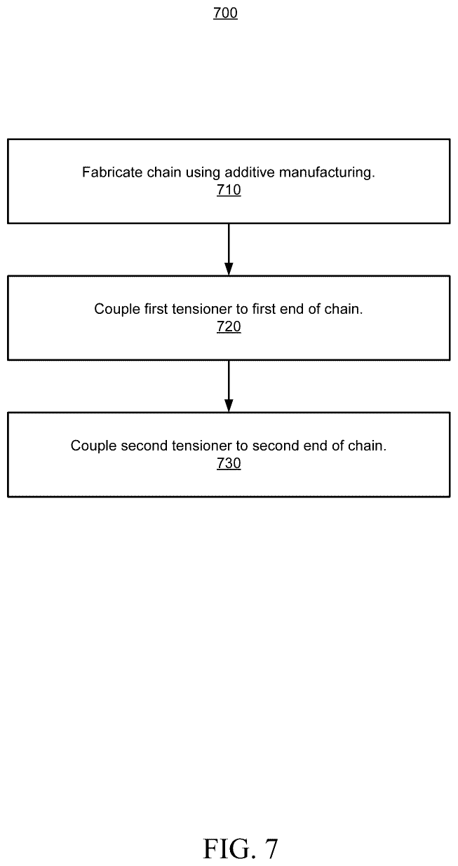

FIG. 7 is a flowchart illustrating a methodology 700 for fabrication of a flexible chain link interconnect, in accordance with an embodiment of the present disclosure. As can be seen, example method 700 includes a number of phases and sub-processes, the sequence of which may vary from one embodiment to another. However, when considered in aggregate, these phases and sub-processes form a process for fabrication of a flexible chain link interconnect using additive manufacturing techniques, in accordance with certain of the embodiments disclosed herein, for example as illustrated in FIGS. 1-6, as described above. However other system architectures can be used in other embodiments, as will be apparent in light of this disclosure. To this end, the correlation of the various functions shown in FIG. 7 to the specific components illustrated in the figures, is not intended to imply any structural and/or use limitations. Rather other embodiments may include, for example, varying degrees of integration wherein multiple functionalities are effectively performed by one system. Numerous variations and alternative configurations will be apparent in light of this disclosure.

In one embodiment, method 700 commences, at operation 710, by performing additive manufacturing to fabricate a chain comprising a plurality of link structures. Each of the link structures is shaped in a continuous and seamless loop and is coupled to at least one adjacent link structure such that a portion of each of the link structure traverses through an interior of the loop of the adjacent link structure. In some embodiments, a conductive material is used to fabricate at least one of the link structures. In some embodiments, a dielectric material is used to fabricate at least one of the link structures. In some embodiments, the continuous and seamless loops may be circularly shaped, for example as an oval. In some embodiments, the continuous and seamless loops may be rectangularly shaped, for example having four linear sides.

In some embodiments, additive manufacturing techniques may be used to fabricate the links out of a dielectric material which may then be electroplated, or otherwise selectively coated, with a conductive metal of desired thickness.

In one example the metal links are fabricated by direct metal laser melting process where particles of the metal are deposited onto the bed and a laser melts the metal powder and forms the links. In yet another example, the metal links may be fabricated using 3D volumetric imaging and deposition.

In some embodiments, the link structures may be on the order of one millimeter in length. In some embodiments, the gap between links may be on the order of 1 micrometer, when the chain is in a slack configuration.

At operation 720, a first tensioner is coupled to a first one of the link structures at a first end of the chain. The first tensioner configured to electrically connect the first link structure to a first circuit element.

At operation 730, a second tensioner is coupled to a second one of the link structures at a second end of the chain. The second tensioner configured to electrically connect the second link structure to a second circuit element. While a first and second tensioner are described, in another embodiment a single tensioner is employed, and the opposite end of the chain link interconnect is coupled directly to the circuit. In yet another example, no tensioners are employed, and the chain link interconnect is coupled to circuits at both ends. Depending upon the expected motion between the circuits, the length of the chain link interconnect and/or number of links can be adjusted to account for the expected motion.

In some embodiments, additional operations may be performed, as previously described in connection with the system. For example, additive manufacturing techniques may be used to fabricate one or more additional chains, which may then be coupled to ground and positioned adjacent to the first chain to provide electrical shielding for the first chain.

In some embodiments, additive manufacturing techniques may be used to fabricate a second chain. A first end of the second chain may be coupled to one of the link structures of the first chain and a second end of the second chain is coupled to a third tensioner. The third tensioner is configured to electrically connect the second end of the second chain to a third circuit element, providing a branch off of the first chain.

In some embodiments, additive manufacturing techniques may be used to fabricate a second chain, using a dielectric material. A first end of the second chain may be coupled to one of the link structures of the first chain and a second end of the second chain is coupled to an attachment point or anchor point such that the second chain is configured to provide stability and relieve stress on the first chain.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood, however, that other embodiments may be practiced without these specific details, or otherwise with a different set of details. It will be further appreciated that the specific structural and functional details disclosed herein are representative of example embodiments and are not necessarily intended to limit the scope of the present disclosure. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is a flexible electrical interconnect comprising: a chain comprising a plurality of link structures wherein each of the link structures is shaped in a continuous and seamless loop and is coupled to at least one adjacent link structure such that a portion of each of the link structure traverses through an interior of the loop of the adjacent link structure; and a tensioner coupled to a first one of the link structures at a first end of the chain and configured to electrically connect the first link structure to a first circuit element.

Example 2 includes the flexible electrical interconnect of Example 1, wherein the tensioner is a first tensioner, and the flexible electrical interconnect comprises a second tensioner coupled to a second one of the link structures at a second end of the chain and configured to electrically connect the second link structure to a second circuit element.

Example 3 includes the flexible electrical interconnect of Examples 1 or 2, wherein the first circuit element is an integrated circuit or an antenna.

Example 4 includes the flexible electrical interconnect of any of Examples 1-3, wherein at least one of the link structures comprise a conductive material and the continuous and seamless loop is a circular shape or a rectangular shape.

Example 5 includes the flexible electrical interconnect of any of Examples 1-4, wherein at least one of the link structures comprise a dielectric material.

Example 6 includes the flexible electrical interconnect of any of Examples 1-5, wherein the tensioner is a spring or a microelectromechanical system.

Example 7 includes the flexible electrical interconnect of any of Examples 1-6, wherein the chain is a first chain, and the flexible electrical interconnect comprises a second chain adjacent to the first chain, wherein the link structures of the second chain are coupled to a ground and configured to provide electrical shielding of the first chain.

Example 8 includes the flexible electrical interconnect of any of Examples 1-7, wherein the chain is a first chain, and the flexible electrical interconnect comprises a second chain, wherein a first end of the second chain is coupled to one of the link structures of the first chain.

Example 9 includes the flexible electrical interconnect of Example 8, wherein a second end of the second chain is coupled to a third tensioner, the third tensioner configured to electrically connect the second end of the second chain to a third circuit element.

Example 10 includes the flexible electrical interconnect of Example 8, wherein a second end of the second chain is coupled to an attachment point such that the second chain is configured to relieve stress on the first chain.

Example 11 is a flexible electrical interconnect comprising: a first link structure shaped in a continuous and seamless loop; a second link structure shaped in a continuous and seamless loop, the second link structure coupled to the first link structure such that a portion of the second link structure traverses through an interior of the loop of the first link structure; and a tensioner coupled to the first link structure and configured to electrically connect the first link structure to a circuit element.

Example 12 includes the flexible electrical interconnect of Example 11, wherein the circuit element is an integrated circuit or an antenna, and the first link structure comprises a conductive material.

Example 13 includes the flexible electrical interconnect of Examples 11 or 12, wherein the second link structure comprises a dielectric material.

Example 14 includes the flexible electrical interconnect of any of Examples 11-13, wherein the continuous and seamless loop is a circular shape or a rectangular shape.

Example 15 is a method for fabricating a flexible electrical interconnect, the method comprising: performing additive manufacturing to fabricate a chain comprising a plurality of link structures wherein each of the link structures is shaped in a continuous and seamless loop and is coupled to at least one adjacent link structure such that a portion of each of the link structure traverses through an interior of the loop of the adjacent link structure; and coupling a tensioner to a first one of the link structures at a first end of the chain, the first tensioner configured to electrically connect the first link structure to a first circuit element.

Example 16 includes the method of Example 15, wherein the tensioner is a first tensioner, and the method further comprises coupling a second tensioner to a second one of the link structures at a second end of the chain, the second tensioner configured to electrically connect the second link structure to a second circuit element.

Example 17 includes the method of Examples 15 or 16, wherein a conductive material is used to fabricate at least one of the link structures and the continuous and seamless loop is a circular shape or a rectangular shape.

Example 18 includes the method of any of Examples 15-17, wherein a dielectric material is used to fabricate at least one of the link structures.

Example 19 includes the method of any of Examples 15-18, wherein the chain is a first chain, and the method further comprises performing additive manufacturing to fabricate a second chain to be positioned adjacent to the first chain, wherein the link structures of the second chain are coupled to a ground and configured to provide electrical shielding of the first chain.

Example 20 includes the method of any of Examples 15-19, wherein the chain is a first chain, and the method further comprises: performing additive manufacturing to fabricate a second chain; coupling a first end of the second chain to one of the link structures of the first chain; and coupling a second end of the second chain to a third tensioner, the third tensioner configured to electrically connect the second end of the second chain to a third circuit element.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A flexible electrical interconnect comprising:
a chain comprising a plurality of link structures wherein each of the link structures is shaped in a continuous and seamless loop and is coupled to at least one adjacent link structure such that a portion of each of the link structure traverses through an interior of the loop of the adjacent link structure; and
a tensioner coupled to a first one of the link structures at a first end of the chain and configured to electrically connect the first link structure to a first circuit element.

2. The flexible electrical interconnect of claim 1, wherein the tensioner is a first tensioner, and the flexible electrical interconnect comprises a second tensioner coupled to a second one of the link structures at a second end of the chain and configured to electrically connect the second link structure to a second circuit element.

3. The flexible electrical interconnect of claim 1, wherein the first circuit element is an integrated circuit or an antenna.

4. The flexible electrical interconnect of claim 1, wherein at least one of the link structures comprise a conductive material and the continuous and seamless loop is a circular shape or a rectangular shape.

5. The flexible electrical interconnect of claim 1, wherein at least one of the link structures comprise a dielectric material.

6. The flexible electrical interconnect of claim 1, wherein the tensioner is a spring or a microelectromechanical system.

7. The flexible electrical interconnect of claim 1, wherein the chain is a first chain, and the flexible electrical interconnect comprises a second chain adjacent to the first chain, wherein the link structures of the second chain are coupled to a ground and configured to provide electrical shielding of the first chain.

8. The flexible electrical interconnect of claim 1, wherein the chain is a first chain, and the flexible electrical interconnect comprises a second chain, wherein a first end of the second chain is coupled to one of the link structures of the first chain.

9. The flexible electrical interconnect of claim 8, wherein a second end of the second chain is coupled to a third tensioner, the third tensioner configured to electrically connect the second end of the second chain to a third circuit element.

10. The flexible electrical interconnect of claim 8, wherein a second end of the second chain is coupled to an attachment point such that the second chain is configured to relieve stress on the first chain.

11. A flexible electrical interconnect comprising:
a first link structure shaped in a continuous and seamless loop;
a second link structure shaped in a continuous and seamless loop, the second link structure coupled to the first link structure such that a portion of the second link structure traverses through an interior of the loop of the first link structure; and
a tensioner coupled to the first link structure and configured to electrically connect the first link structure to a circuit element.

12. The flexible electrical interconnect of claim 11, wherein the circuit element is an integrated circuit or an antenna, and the first link structure comprises a conductive material.

13. The flexible electrical interconnect of claim 11, wherein the second link structure comprises a dielectric material.

14. The flexible electrical interconnect of claim 11, wherein the continuous and seamless loop is a circular shape or a rectangular shape.

15. A method for fabricating a flexible electrical interconnect, the method comprising:
performing additive manufacturing to fabricate a chain comprising a plurality of link structures wherein each of the link structures is shaped in a continuous and seamless loop and is coupled to at least one adjacent link structure such that a portion of each of the link structure traverses through an interior of the loop of the adjacent link structure; and
coupling a tensioner to a first one of the link structures at a first end of the chain, the first tensioner configured to electrically connect the first link structure to a first circuit element.

16. The method of claim 15, wherein the tensioner is a first tensioner, and the method further comprises coupling a second tensioner to a second one of the link structures at a second end of the chain, the second tensioner configured to electrically connect the second link structure to a second circuit element.

17. The method of claim 15, wherein a conductive material is used to fabricate at least one of the link structures and the continuous and seamless loop is a circular shape or a rectangular shape.

18. The method of claim 15, wherein a dielectric material is used to fabricate at least one of the link structures.

19. The method of claim 15, wherein the chain is a first chain, and the method further comprises performing additive manufacturing to fabricate a second chain to be positioned adjacent to the first chain, wherein the link structures of the second chain are coupled to a ground and configured to provide electrical shielding of the first chain.

20. The method of claim 15, wherein the chain is a first chain, and the method further comprises:
performing additive manufacturing to fabricate a second chain;
coupling a first end of the second chain to one of the link structures of the first chain; and
coupling a second end of the second chain to a third tensioner, the third tensioner configured to electrically connect the second end of the second chain to a third circuit element.
